(19) United States
(12) Patent Application Publication
(10) Pub. No.: US 2022/0019977 A1
(43) Pub. Date: Jan. 20, 2022

(54) System For Measuring And Promoting Diversity And Inclusion

(71) Applicant: Asmau Ahmed, New York, NY (US)

(72) Inventor: Asmau Ahmed, New York, NY (US)

(21) Appl. No.: 17/237,800

(22) Filed: Apr. 22, 2021

Related U.S. Application Data
(60) Provisional application No. 63/053,002, filed on Jul. 17, 2020.

(51) Int. Cl. G06Q 10/10; G06Q 10/06

(52) U.S. Cl. CPC G06Q 10/1053; G06Q 10/06395

(57) ABSTRACT

A system for measuring and promoting diversity and inclusion having a computer, a user device in communication with said computer and being associated with a person, a questionnaire provided by said computer to said user device including a plurality of questions regarding attributes associated with at least one of the person's identity, interests, and career, a response to the questionnaire received by said computer from said user device, said response including answers to at least some of the questions, a database in communication with said computer for storing said questionnaire and response, a group device in communication with said computer, said group device collecting responses from a group of associated persons, a desired characteristic/skill submitted by said group device to said computer, said computer recommending at least one new person to the group based on at least in part on the diversity with the associated persons of the group.

### TECHNICAL FIELD

The present invention relates to a system for promoting diversity and inclusion within groups of people.

### BACKGROUND

Our society is diverse, yet our workplaces, inner circles, and experiences are not. Differences between people should be celebrated discovered, and explored so that biases may be dispelled, making the world more diverse and inclusive.

For example, companies have a hard time hiring diverse talent, in large part due to their inability to reach qualified, diverse candidates. As a result, we promote homogeneity as people continue to hire people they know. This leads to a lack of empathy for others, and stunts creativity, innovation and shareholder value. Underrepresented communications, therefore, remain economically disadvantaged. A platform is required that diversifies job pipelines and relationship networks with qualified and underrepresented candidates.

As another example, individual's inner circles are sometimes less diverse than our society as a whole. Social medial proliferates the like-follows-like mentality. As a result, the news we receive reinforces what an individual has already believed. This again leads to a lack of empathy for others, and stunts creativity, innovation and growth. Individuals remain unintentionally segregated. This happens in both activity circles, where people convene around an activity of interest or goal, and opinion circles in which trending news can have societal importance. A platform is required that diversifies those we come into contact with when we explore our interests and opinions.

As another example, an individual may have experiences that defined or promoted by their own personal history, and may not be aware of other experiences or cultures. For instance, a fan of contemporary fiction may be unaware of books, poems, or stories that are outside of their cultural circle. This again leads to a lack of empathy for others, and stunts creativity, innovation and growth. A platform is required that helps a person pick products and services that diversify their life and perspective.

### SUMMARY

In accordance with the above, the present invention relates to a system that helps promote diversity and inclusion by recommending people to groups and products/services in order to capitalize on society's diverse makeup.

In one aspect of the invention, a system for measuring and promoting diversity and inclusion is provided, having a computer, a user device in data communication with said computer, said user device being associated with a person, a questionnaire provided by said computer to said user device, said questionnaire including a plurality of questions regarding attributes associated with at least one of the person's identity, interests, and career, a response to the questionnaire received by said computer from said user device, said response including answers to at least some of the questions, a database in data communication with said computer for storing said questionnaire and response, a group device in data communication with said computer, said group device collecting responses from a group of associated persons, a desired characteristic/skill submitted by said group device to said computer, said computer recommending at least one new person to the group based on at least in part on the diversity with the associated persons of the group.

In another aspect of the invention, a system for promoting diversity and inclusion is provided having a computer, a user device in data communication with said computer, said user device being associated with a person, a questionnaire provided by said computer to said user device, said questionnaire including a plurality of questions regarding attributes associated with at least one of the person's identity, interests, and career, a response to the questionnaire received by said computer from said user device, said response including answers to at least some of the questions, a database in data communication with said computer for storing said questionnaire and response, a third-party device in data communication with said computer, said group device collecting responses from persons associated with a product or service, said computer recommending at least one product or service to a new person based at least in part on the diversity of persons associated with a product or service.

### BRIEF DESCRIPTION OF THE DRAWINGS

FIG. 1 is a schematic view of the system of the present invention.

### DETAILED DESCRIPTION

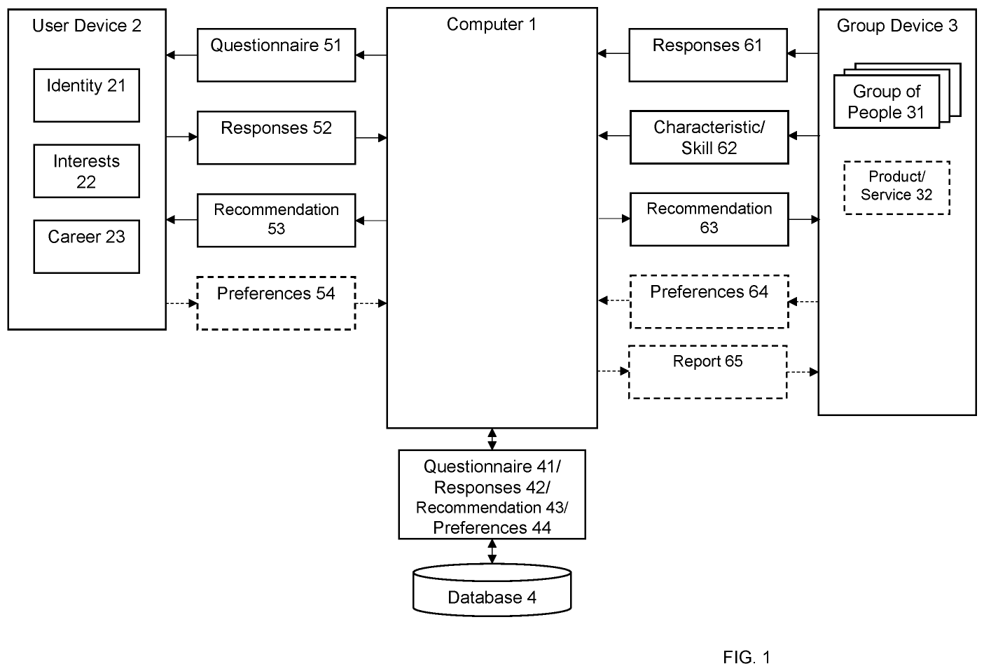

Referring to FIG. 1, the present disclosure describes a system 10 for measuring and promoting diversity and inclusion.

The system 10 includes a computer 1. The computer 1 may be a processor, remote computer, computer server, network, or any other computing resource, including mobile devices.

The computer 1 may be in communication with a user device 2. The user device 2 may be a computer, laptop, smartphone, tablet, or other electronic device, including mobile devices, capable of transmitting data to the computer 1. The user device 2 may also include cloud databases accessible to such an electronic device, such as Dropbox or OneDrive. The user device 2 may run an application on a mobile device or smartphone.

The user device 2 may be associated with a particular person. The person has attributes, including identity 21, interests 22, and a career 23.

Identity attributes 21 may include, but are not limited to: gender, pronouns, race, religion, sexual orientation, age range, ethnicity/geographic/regional background, socio-economic class, mental ability, physical ability, family/parenting makeup, political beliefs, language spoken at home, academic background, n-generation immigrant, and military service. Identity attributes 21 may also include temporary states, such as whether a person is pregnant, has a temporary health condition, or is a foster parent (to a child or pet). Identity attributes may also include things that the person is not.

Interests 22 may include, but are not limited to: beauty & fashion, food & dining, home & garden, art & theater aficionados, career growth and job seekers, family-focused activities, green living enthusiasts, outdoor enthusiasts, pet lovers, photography, thrill seekers, media & entertainment, book lovers, gamers, news & politics, health, wellness & fitness, sports fans, technophiles, travel, cars, and art. Interests 22 may also be defined by what a person is not interested in.

A person's career 23 may be defined by their level (e.g., entry, mid-level, executive, board member, CEO/founder, C-level, VP, director, manager, associate, analyst, intern, other), industry (e.g., technology, finance, media, consumer, hospitality, other) and/or function (e.g., engineering, finance, management consulting, marketing, human resources, legal, strategy, operations, accounting, data science, product management, project management, business development, other). The career 23 may also be defined by their current position (e.g., role, company, title, and location), and previous positions (roles, titles, companies, descriptions, locations, start and end dates). A person may also have important characteristics for their next position (e.g., company size, culture, manager, travel, flexible schedule, flexible location, benefits, level).

The user device 2 may also provide preferences 54 to the computer 1. The preferences 54 may indicate how important particular attributes are to a person. For instance, a person interest surrounding themselves with others of different faiths may so indicate.

The user device 2 may receive a questionnaire 51 containing questions the person's identity 21, interests 22, and career 23. The user device 2 may send responses 52 to the questions. The user device 2 need not send a response to every questions. For instance, if a person does not want to divulge their ethnicity or religion, they can leave those questions blank.

The computer 1 may be in communication with a group device 3. The group device 3 may be a computer, laptop, smartphone, tablet, or other electronic device, including mobile devices, capable of transmitting data to the computer 1. The group device 3 may also include cloud databases accessible to such an electronic device, such as Dropbox or OneDrive. The group device 3 may run an application on a mobile device or smartphone.

The group device 3 may be associated with a group of people. The group of people could be any group, physical or electronic. The group of people may be a company, or may be a division or a team within a company. The group of people may also be centered around a common interest, activity, or opinion. The group of people may be people invited to an event. For example, in the case an email invite is sent out, the group of people could be the group that is invited, or has accepted the invite. The group of people could also be people associated with a conversation, such as an online (social media, forums, or news comments) or in-person conversation. Each person in the group has their own attributes, including identity 21, interests 22, and a career 23.

The group device 3 may send provide responses 61 to the questionnaire 41 for each person in the group. Alternatively, each person in the group may provide their own responses 52 from their own user device 2. Still further, a group device 3 may provide responses 61 that are representative of their group, but not indicative of any individual person. That is, a company may provide generalized statistics (e.g. 55% female, 40% male, 5% non-binary).

The group device 3 may also provide a characteristic/skill 62 that they are looking for in someone to join their group. For instance, a company may be looking for a person with 5 years' experience in web development, or book club may be looking for someone with an interest in reading Asian literature. The group device 3 may provide an indication of the attributes that will make the group more device and regarding the culture of the group.

The group device 3 may also provide preferences 64 to the computer 1. The preferences 64 may indicate how important particular attributes are to group. For instance, a group interested in increasing the diversity of where their members are from may so indicate. The preferences 64 may indicate a desire to be over-inclusive.

The group device 3 may also provide a group profile. The group profile may include information about the group, including its name, an “about us” section, a commitment to diversity and inclusion, links to websites, social media, and relevant articles, when the group was founded, and its industry/activity/interest. A group device 3 may also indicate interests that they are active in, such as “Nike” for “Health/Fitness” or a bird watching club for “Outdoors Lifestyle.”

The computer 1 may look at the identity 21, interests 22, and career 23 of each individual member of a group to determine the diversity of a group. For example, the computer 1 analyze the identity of the group. The computer may, for example, look at each of the identity attributes (e.g., gender, pronouns, race, religion, sexual orientation, age range, ethnicity/geographic/regional background, socio-economic class, mental ability, physical ability, family/parenting makeup, political beliefs, language spoken at home, academic background, n-generation immigrant, and military service.)

For each attribute, the computer 1 may assign a diversity rating based on the number of different answers for each attribute in the group. The diversity rating may be based on the diverse makeup of the group as compared to the diversity of society. For example, the diversity rating may look at whether there are 1, 2, or 3 or more different answers for each identity attribute. For instance, for gender, if the group is made up solely of males, the diversity would be 0%. A group with an even distribution between male and transgender for example, could receive a diversity of 90%. A group with male, female, transgender, and non-binary people could receive a diversity of 100%. These diversity ratings, and the number of different answers required for each, can be modified based on the individual attributes.

The computer 1 may also weigh the individual attributes. For example, gender may be worth 15% of the total diversity rating, while academic background may be 2.5% This accounts for groups, such as research laboratories, who may require a disproportionately high number of Ph.Ds. These weights may be based on the distribution of people in the country with those particular attributes. For example, if 80% of a country shares the same religion, the diversity rating should not be penalized if a group reflects that 80%. Preferences 54, 64 may be taken into account and allow the user device 2/group device 3 to customize the weights, if, for example, they wish to be over-inclusive of people of different backgrounds.

The computer may rate a group's diversity on a scale. For example, if a group receives aggregate diversity rating between 0-25% diversity, the computer may rate the company's diversity as “BAD.” 26-50% may be “FAIR”, 51-75% may be “GOOD” and 76-100% may be “EXCELLENT.” These percentages may vary, and more or less categories may be used. For example, another scale may be <40% BAD, 40-60% FAIR, 60-80% GOOD, and >80% EXCELLENT. These ratings may be based on the diverse makeup of society as a whole. Preferences 54, 64 may be taken into account and allow the user device 2/group device 3 to customize these values.

Alternatively, the computer may determine the diversity based on the number of attributes that had at least two different answers represented. For example, BAD could indicate that 0-1 attributes had more than two different responses, FAIR 2, GOOD 3-4, and EXCELLENT 5. The number of answers required and number of attributes for each rank may vary based on needs. Preferences 54, 64 may be taken into account and allow the user device 2/group device 3 to customize these values.

Based on the diversity of the group, the computer may make a recommendation 53, 63 to the user device 2 or the group device 3, respectively. The recommendation 53, 63 may recommend a person to a group or vice versa. In making the recommendation, the computer may also take the characteristic/skill 62 and preferences 54, 64 into account. This, for example, ensures that all people recommended to a company for hire meet minimum competency requirements. As part of the recommendation 63, the computer 1 may provide the responses 52 to the group device 3.

As part of the recommendation 53, the computer may provide the diversity of the group to the user device 3. The diversity may be personalized to the user device 3 based on preferences 54, for example, if the user deems a diverse group based on sexual orientation is important.

The recommendation 63 may include more than one person, the people being ordered based on their potential impact to the diversity of the group. This helps to uncover and bring underrepresented people to the forefront of job searches, and allows activity/interest groups to diversify their membership with people that may have different backgrounds. For example, a pool of qualified job candidates may be provided, and ordered based on their impact on the diversity of a company so that underrepresented candidates are uncovered.

In addition, the group device 3 may be associated of a group of products or services 32. For example, the group device 3 may be related to cultural media or travel destinations. Products or services 32 therefore may include a book, a movie, a song, a podcast, a news outlet, a travel destination, or other cultural experiences. In this way, the group device 3 may aggregate responses 61 regarding those who purchased or enjoyed particular products or services. The computer 1 may then associate a diversity with each product or service 32. The computer 1 may then send a recommendation 53 for a product or service 32 based on the group of people who typically enjoy the product or service 32. That is, an avid reader in a with a majority attribute may receive a recommendation for a book typically enjoyed by those with a minority attribute. Similarly, if a people with a specific attribute typically travel to a specific state or country, people without that attribute, who do not typically make that travel, may be recommended to that area.

The system 10 may also be used to track the diversity of a group of people attending an event. For example, responses may be provided by event attendees or retrieved from previously provided responses, for example, if the email addresses of attendees is known. The diversity of the group of people invited to and/or confirmed attending the event may be sent to the event organizer's group device 3. At this point, the event organizer may step up initiatives to promote the diversity of their event.

In addition, the system 10 may be used to evaluate the participants in a conversation. For example, the diversity of people responding to a social media post may help reveal the post's audiences biases and/or the effect of an “echo chamber.” The diversity could be displayed next to the post, and help social media users understand the information they are being provided. The same could be done for forums and news media.

The system 10 may also be used to help group organizers maintain and promote diversity within their groups. The computer 1 may track the diversity of a group over time and provide reports 65 to the group device 3 based thereon. The report 65 may show, for example, how diversity and inclusion initiates have impacted the diversity of group.

The computer 1 may be in communication with a database 2. The database 2 may store and retrieve information regarding the system 10, including a questionnaire 41, response 42, recommendation 43, and/or preferences 44. When storing information, the database may include additional meta-information. For example, it may store the identity of the user from which the data came, a date and time stamp, or any other meta-information that may be useful to the system 10.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for measuring and promoting diversity and inclusion, comprising:
a computer;
a user device in data communication with said computer, said user device being associated with a person;
a questionnaire provided by said computer to said user device, said questionnaire including a plurality of questions regarding attributes associated with at least one of the person's identity, interests, and career;
a response to the questionnaire received by said computer from said user device, said response including answers to at least some of the questions;
a database in data communication with said computer for storing said questionnaire and response;
a group device in data communication with said computer, said group device collecting responses from a group of associated persons;
a desired characteristic/skill submitted by said group device to said computer, said computer recommending at least one new person to the group based on at least in part on the diversity with the associated persons of the group.

2. The system of claim 1, wherein the person is a job candidate and the group is a company looking to hire.

3. The system of claim 2, the candidate being shown a representation of the diversity of the company.

4. The system of claim 2, the computer recommending multiple new people to the company, ordered based at least in part on how each person's inclusion in the company would affect the company's diversity.

5. The system of claim 2, the group being indicative of the company as a whole, or a subset of the company, such as a division or team within the company.

6. The system of claim 1, wherein the groups are centered around shared interests or goals.

7. The system of claim 6, the computer recommending multiple new people to the group, ordered based at least in part on how each person's inclusion in the group would affect the group's diversity.

8. The system of claim 1, wherein identity attributes include at least one of gender, pronouns, race, religion, sexual orientation, age range, ethnicity/geographic/regional background, socio-economic class, mental ability, physical ability, family/parenting makeup, political beliefs, language spoken at home, academic background, n-generation immigrant, and military service.

9. The system of claim 1, wherein identity attributes may be temporary, such temporary identity attributes including pregnancy status, health status, and foster parent.

10. The system of claim 1, comprising the computer saving for a representation of the diversity of the group at a predetermined frequency and providing a report to the group device showing changes over time.

11. The system of claim 1, the user device or the group device sending preferences to said computer for how to determine diversity.

12. The system of claim 1, the diversity of the group being measured against the diversity of society or a subset thereof.

13. The system of claim 1, the diversity of the group being rated on a scale from bad to fair to good to excellent.

14. The system of claim 13, the scale being based on weighted averages of attributes of the associated persons of the group.

15. The system of claim 13, the scale including bad (<40%), fair (40-60%), good (60-80%), and excellent (>80%).

16. The system of claim 13, the scale being based a count of the differences in each attribute for the associated persons of the group.

17. A system for promoting diversity and inclusion, comprising:
a computer;
a user device in data communication with said computer, said user device being associated with a person;
a questionnaire provided by said computer to said user device, said questionnaire including a plurality of questions regarding attributes associated with at least one of the person's identity, interests, and career;
a response to the questionnaire received by said computer from said user device, said response including answers to at least some of the questions;
a database in data communication with said computer for storing said questionnaire and response;
a third-party device in data communication with said computer, said group device collecting responses from persons associated with a product or service;
said computer recommending at least one product or service to a new person based at least in part on the diversity of persons associated with a product or service.

18. The system of claim 17, the computer recommending multiple products or services ordered based at least in part on the diversity of persons associated with each product or service.

19. The system of claim 17, wherein the product or service is at least one of a book, a movie, a song, a podcast, a news outlet, a travel destination, or other cultural experience.
